(19) United States
(12) Patent Application Publication
(10) Pub. No.: US 2025/0241736 A1
(43) Pub. Date: Jul. 31, 2025

(54) ELECTRIC TOOTHBRUSH HEAD AND ELECTRIC TOOTHBRUSH

(71) Applicant: Jianhua Zhang, Huizhou City (CN)

(72) Inventor: Jianhua Zhang, Huizhou City (CN)

(21) Appl. No.: 18/830,296

(22) Filed: Sep. 10, 2024

Related U.S. Application Data
(63) Continuation-in-part of application No. 18/586,616, filed on Feb. 26, 2024, now Pat. No. 12,114,766.

(30) Foreign Application Priority Data
Jan. 29, 2024 (CN) 202410125864.X

(51) Int. Cl. A61C 17/22

(52) U.S. Cl. CPC A61C 17/222

(57) ABSTRACT

An electric toothbrush brush head and an electric toothbrush are provided. The electric toothbrush head is configured for connecting a driving shaft of the electric toothbrush, and the electric toothbrush head includes a head portion having bristles, and a rod portion extending from the head portion. The rod portion is provided with a groove for being connected to the driving shaft, so that the driving shaft can be inserted into the groove to transmit a vibration to the rod portion. A rotation angle reducing assembly is arranged between the rod portion and the driving shaft to allow a rotation angle of the rod portion less than that of the driving shaft.

### CROSS-REFERENCE TO RELATED APPLICATION

This application is a continuation in part of U.S. utility application Ser. No. 18/586,616 filed Feb. 26, 2024, which claims the benefit of a Chinese Patent Application with No. 202410125864.X, titled “ELECTRIC TOOTHBRUSH HEAD AND ELECTRIC TOOTHBRUSH”, filed on Jan. 29, 2024. The entire contents of the above-identified patent applications are incorporated herein by reference.

### FIELD OF THE INVENTION

The present invention relates to the field of electric toothbrush technology, especially to an electric toothbrush head and an electric toothbrush having same.

### BACKGROUND OF THE INVENTION

An electric toothbrush can drive a brush head thereof to produce a high-frequency movement through a rapid rotation or vibration of a motor core, so that toothpaste can be quickly decomposed into fine foam, and teeth can be thoroughly cleaned. In order to extend a service life of an electric toothbrush, a brush handle with a driving shaft at the end and the brush head with bristles is usually detachably connected, so that when the bristles on the brush head deform severely, the brush head can be replaced.

The existing brush heads are generally connected to the driving shafts through connectors. Specifically, both the brush head and the connector are internally hollow. When installing, the connector is fixed inside the brush head, and then the driving shaft is fixed inside the connector to fix the brush head on the driving shaft. However, this connection will cause the vibration of the driving shaft to be not directly transmitted to the brush head, vibration will be hindered and attenuated by the connector during transmission, thereby affecting the vibration frequency of the bristles.

### SUMMARY OF THE INVENTION

### (1) Solved Technical Problem

To solve the above problems, the present invention provides an electric toothbrush head and an electric toothbrush, which can directly transmit the vibration of the driving shaft to the head portion.

### (2) Technical Solution

To achieve the above objectives, the present invention provides the following technical solution:

An electric toothbrush head for connecting a driving shaft of an electric toothbrush includes a head portion having bristles, and a rod portion extending from the head portion. The rod portion is provided with a groove for being connected to the driving shaft, so that the driving shaft can be inserted into the groove to transmit a vibration to the rod portion. A rotation angle reducing assembly is arranged between the rod portion and the driving shaft to allow a rotation angle of the rod portion less than that of the driving shaft.

In a preferred embodiment, wherein the driving shaft can rotate back and forth, and the rod portion and the driving shaft have relative rotational space, and the rotation angle reducing assembly includes: a first sector portion located at an end of the driving shaft; and a second sector portion located within the groove, a radius of the groove is greater than that of the driving shaft, and a sum of the angles of the second sector portion and the first sector portion is less than 360°, such that there is a vacant angular space between the driving shaft and the side of the second sector, the driving shaft being idle for an angle before contacting a side surface of the second sector portion and driving the electric toothbrush head to rotate during each reciprocating rotation, and thus a rotation angle of the rod portion is less than that of the driving shaft.

In a preferred embodiment, the electric toothbrush head further includes a rotation limiting assembly, wherein the rotation limiting assembly is configured to limit an inertial rotation range of the rod portion.

In a preferred embodiment, the rotation limiting assembly includes a shell, a limiting groove and a limiting protrusion, a lower end of the shell is configured to be connected to a handle of the electric toothbrush, the limiting groove is located at the shell, the limiting protrusion is located on the rod portion, such that when the rod portion is inserted in the shell and connected to the driving shaft, the limiting protrusion is received in the limiting groove, during rotation, one end of the limiting protrusion can contact one end of the limiting groove after being driven by the driving shaft to rotate a certain angle, at this time, the limiting groove will prevent the limiting protrusion from continuing to rotate any excess angle due to inertia.

In a preferred embodiment, the limiting protrusion and limiting groove are both in a sector shape, and an arc length of the limiting groove is greater than that of the limiting protrusion.

In a preferred embodiment, the shell includes a top opening, a bottom opening and a middle partition with a channel, an internal space of the shell is divided into an upper chamber and a lower chamber by the middle partition, and the channel connects the upper chamber and the lower chamber, the limiting groove is set in the upper chamber, and the rod portion is inserted into the upper chamber through the top opening of the shell, the driving shaft is connected to the rod portion through the bottom opening and the channel, and the lower chamber is detachably sleeved on the handle of the electric toothbrush.

In a preferred embodiment, the head portion is detachably connected to the rod portion, the groove is equipped with a first limiting portion, and the driving shaft is equipped with a second limiting portion corresponding to the first limiting portion, the rod portion and the driving shaft are detachably connected through the fit of the first limiting portion and the second limiting portion.

In a preferred embodiment, an elastic portion is provided at a side wall of the groove, and the first limiting portion is set on a side of the elastic portion close to the driving shaft.

In another aspect, an electric toothbrush is provided, the electric toothbrush includes a handle and an electric toothbrush brush head, wherein a driving shaft being provided on the handle, and the electric toothbrush head is detachably connected to the driving shaft.

### (3) Beneficial Effects

Compared with the prior art, the present invention brings the following beneficial effects:

In actual use, the driving shaft is inserted into the groove of the rod portion, and the relative position of the rod portion and the driving shaft is fixed through the matching connection of the first and second limiting portions. Then, the electric motor core inside the electric toothbrush is started to drive the driving shaft to generate high-frequency motion, which can enable the bristles on the head portion to brush teeth. As the driving shaft in present scheme is directly in contact with the rod portion, which is a part of the brush head, the vibration of the driving shaft can be directly transmitted to the head portion. The vibration transmission process is not hindered by other components, and there is no attenuation or less attenuation, so the vibration frequency of the bristles is not affected or less affected than the existing electric toothbrushes on the market, resulting that the vibration frequency of bristles is higher. Overall, by using the electric toothbrush head, the vibration of the driving shaft can be directly transmitted to the head portion.

### BRIEF DESCRIPTION OF THE DRAWINGS

FIG. 1 is a schematic structural view of an electric toothbrush according to an embodiment of present invention.

FIG. 2 is an exploded schematic structural view of the electric toothbrush of FIG. 1.

FIG. 3 is an enlarged view of A part of FIG. 2.

FIG. 4 is a cross sectional view of the electric toothbrush of FIG. 1.

FIG. 5 is an enlarged view of B part of FIG. 4.

FIG. 6 is a cross sectional view of the electric toothbrush from C-C direction showed in FIG. 4.

FIG. 7 is a cross sectional view of the electric toothbrush from D-D direction showed in FIG. 4.

FIG. 8 is a schematic structural view of a shell according to an embodiment of present invention.

FIG. 9 is a cross sectional view of the shell of FIG. 8.

FIG. 10 is a bottom plan view of the electric toothbrush head of FIG. 2.

FIG. 11 is a schematic structural view of the handle of the electric toothbrush of FIG. 2.

Labels in the drawing: 1, driving shaft; 2, head portion; 3, rod portion; 32, elastic portion; 300, rod upper section; 301, rod upper section; 302, limiting plane; 4, groove; 5, first limiting portion; 6, second limiting portion; 81, shell; 810, middle partition; 811, upper chamber; 812, lower chamber; 9, rotation limiting assembly; 91, limiting protrusion; 92, limiting groove; 10, rotation angle reducing assembly; 103, first sector portion; 104, second sector portion; 11, handle; 111, protrusion.

### DETAILED DESCRIPTION OF PREFERRED EMBODIMENTS

The following will provide a clear and complete description of the technical solution in the embodiments of the present invention, in conjunction with the accompanying drawings. Obviously, the described embodiments are only a part of the embodiments of the present invention, not all of them. Based on the embodiments in the present invention, all other embodiments obtained by ordinary technicians in the art without creative labor fall within the scope of protection of the present invention.

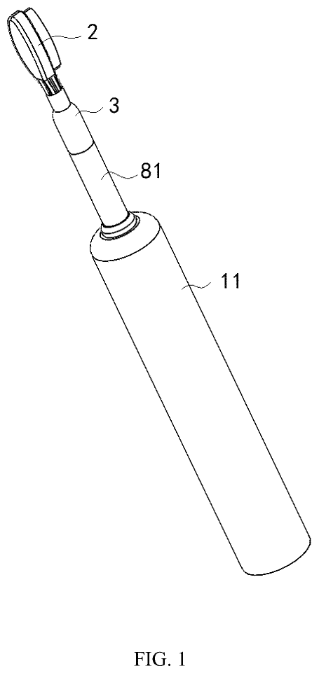

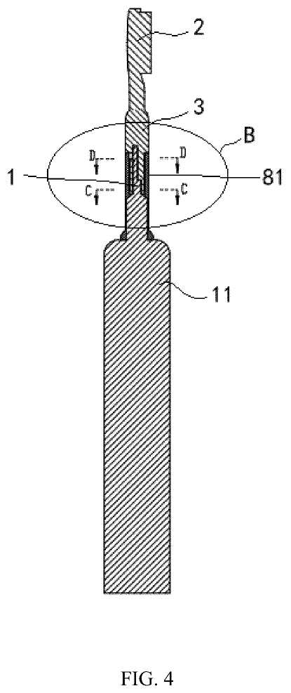

Referring to FIGS. 1-5, an electric toothbrush head is provided for connecting a driving shaft 1 of an electric toothbrush. The electric toothbrush head includes a head portion 2 having bristles, and a rod portion 3 extending from the head portion 2. The rod portion 3 extends a distance between the head portion 2 and the driving shaft 1. The rod portion 3 has a groove 4 configured for being slidably connected to the driving shaft 1, so that the driving shaft 1 can be inserted into the groove 4 and directly transmit the generated vibration to rod portion 3.

In actual use, insert the driving shaft 1 into the groove 4 and fix the relative position between the rod portion 3 and the driving shaft 1. Then, start the motor core inside the electric toothbrush to drive the driving shaft 1 to generate high-frequency motion, which can enable the bristles on the head 2 to brush teeth. As the driving shaft 1 in present scheme is directly in contact with the rod portion 3, which is a part of the brush head, therefore, the vibration of driving shaft 1 can be directly transmitted to the brush head, and the vibration will not be obstructed by other components during the transmission process. The vibration transmission has no attenuation or a small attenuation, so that the vibration frequency of the bristles is not affected or less affected. Compared with existing electric toothbrushes on the market, the vibration frequency of the bristles is higher. Overall, by using the electric toothbrush head, the vibration of driving shaft 1 can be directly transmitted to the brush head.

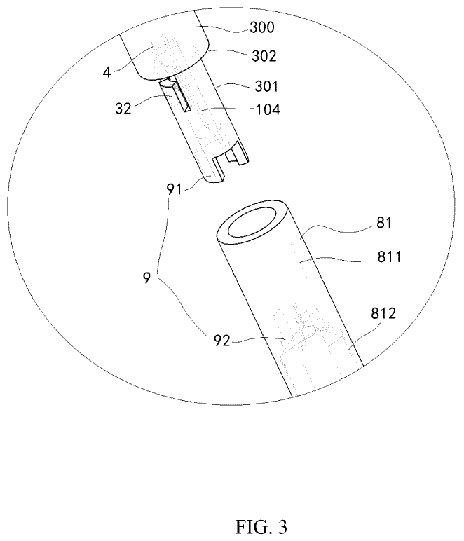

Referring to FIGS. 3-5, the groove 4 is provided with a first limiting portion 5, and the driving shaft 1 is provided with a second limiting portion 6 corresponding to the first limiting portion 5. The rod portion 3 and the driving shaft 1 are detachably connected through the cooperation of the first limiting portion 5 and the second limiting portion 6. In order to more clearly introduce the structure of the electric toothbrush head, the following design is carried out in this embodiment. Specifically, the first limiting portion 5 is an elastic arc-shaped convex structure, and the second limiting portion 6 is an arc-shaped groove structure corresponding to the first limiting portion 5, so that when the driving shaft 1 is inserted into the groove 4, the first limiting portion 5 and the second limiting portion 6 can be connected with buckles.

Specifically, a side wall of the groove 4 is provided with an elastic portion 32, and the first limiting portion 5 is set on the side of the elastic portion 32 close to the groove 4. Therefore, when the driving shaft 1 is inserted into the groove 4, the driving shaft 1 presses the first limiting portion 5, causing the elastic portion 32 to bend outward. When the first limiting portion 5 slides into the second limiting portion 6, the second limiting portion 6 is engaged.

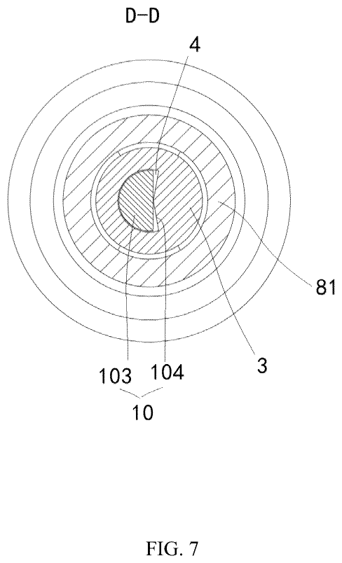

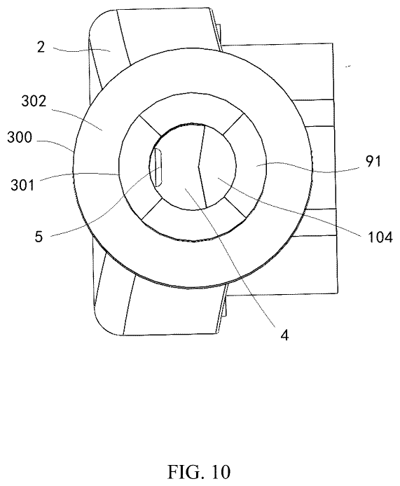

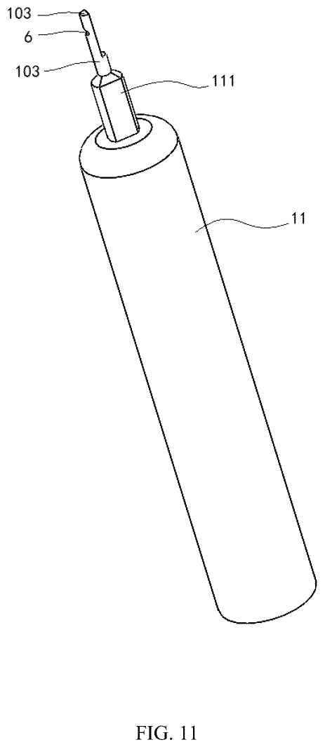

On some electric toothbrushes, the driving shaft 1 rotates back and forth at an angle which is too large and difficult to adjust under the action of the motor core, which may cause the bristles to brush the gums. In order to make the brush head of this electric toothbrush suitable for more electric toothbrushes, refer to FIGS. 7, 10, and 11, in this embodiment, the following design is made: a rotation angle reducing assembly 10 is provided between the rod portion 3 and the driving shaft 1 to reduce the rotation angle of the rod portion 3 relative to the driving shaft 1. The driving shaft 1 can rotate back and forth, and the rotation angle reducing assembly 10 is set between the rod portion 3 and the driving shaft 1 to reduce the rotation angle of the rod portion 3 relative to the driving shaft 1, so that the rotation angle of the rod portion 3 is less than that of the driving shaft 1.

By designing the above structure, the rotation angle of the bristles can be limited within a reasonable range, which can simultaneously brush the upper and lower teeth without causing damage to the gums.

In actual production design, the difference between the rotation angle of the rod portion 3 and the rotation angle of the driving shaft 1 can be selectively designed, so as to flexibly control the rotation range of the electric toothbrush head.

Based on the above scheme, the specific structure of the rotation angle reducing assembly 10 in this embodiment is designed as follows. The groove 4 and the driving shaft 1 are both fan-shaped, so that the rod portion 3 and the driving shaft 1 have relative rotation space. The rotation angle reducing assembly 10 includes: a first sector portion 103 located at the end of the driving shaft 1, and a second sector portion 104.

The second sector portion 104 is located inside the groove 4. In this embodiment, the second sector portion 104 is a partially solid structure inside the rod portion 3. That is, the interior of the rod portion 3 is divided into a solid second sector portion 104 and the groove 4 in fan-shaped. The radius of the groove 4 is greater than the radius of the driving shaft 1, and the sum of the angles between the second sector portion 104 and the first sector portion 103 is less than 360 degrees, so that there is a vacant angular space between the driving shaft 1 and the side of the second sector portion 104. During each reciprocating rotation, the driving shaft 1 will first idle for a certain angle before coming into contact with the side of the second sector portion 104 and driving the electric toothbrush head to rotate. Therefore, the angle between the second sector portion 104 and the driving shaft 1 is less than 360 degrees. The rotation angle should be less than the rotation angle of driving shaft 1.

Through the design of the above structure, the rod portion 3 and the second sector portion 104 can be made to rotate due to inertia until they reach the same forward rotation angle as the driving shaft 1, and have already come into contact with the first sector portion 103 that rotates in the opposite direction, so that the rotation range of the rod portion 3 is less than that of the driving shaft 1.

Furthermore, the radius of the groove 4 is 0.1 mm greater than the radius of the driving shaft 1. In addition, the groove 4 can also have the same radius as the driving shaft 1, which can also achieve the above functions.

It should be noted that the “greater than” in the above statement “the radius of the groove 4 is greater than the radius of the driving shaft 1” should not affect the rotation of the rod portion 3 relative to the driving shaft 1.

It should be noted that the forward and reverse directions mentioned above specifically refer to the two directions in which driving shaft 1 rotates back and forth. For a clearer explanation, here are two examples:

### First Embodiment

Based on the above scheme, it can be seen that there are two sets of opposite side surfaces between the first sector portion 101 and the second sector portion 102. Let the first side surface of the first sector portion 101 opposite to the first side surface of the second sector portion 102, and let the second side surface of the first sector portion 101 opposite to the second side surface of the second sector portion 102.

For example, taking the first side surface of the first sector portion 101 contacts the first side surface of the second sector portion 102 in its natural state as an example, defining a reference plane, and let the driving shaft 1 have a forward and reverse angle of 10° relative to the reference plane, and let the sum of the angles of the second sector portion 102 and the first sector portion 101 be 355°, at this time, there is only 5° angle space between the second side surface of the first sector portion 101 and the second side surface of the second sector portion 102.

When the driving shaft 1 rotates forward, taking the second side surface of the first sector portion 101 as an example, which can approach and contact the second side surface of the second sector portion 102 during the forward rotation process, the second side surface of the first sector portion 101 will be idle 5° before contacting the second side surface of the second sector portion 102. Therefore, while the first side sector portion 101 rotates forward by 10°, the second surface of the second side sector portion 102 only rotates forward by 5°, there is a 5° angle space between the first side surface of the first sector portion 101 and the first side surface of the second sector portion 102. Afterwards, the first sector portion 101 reverses under the drive of the driving shaft 1, but the second sector portion 102 continues to rotate forward under the action of inertia. Due to the influence of factors such as friction between the driving shaft 1 and the groove 4 and air resistance during the inertia rotation process, the forward rotation speed of the second sector portion 102 decreases, but the speed at which the first sector portion 101 reverses under the drive of the driving shaft 1 does not decay, therefore, the forward rotation angle of the second sector portion 102 under inertia is less than the reverse angle of the first sector portion 101, that is, the forward rotation angle of the second sector portion 102 under inertia is less than 2.5°, that is, a total forward rotation angle of the second sector portion 102 is less than 2.5°.

When the driving shaft 1 is reversed, the first side surface of the first sector portion 101 contacts the first side surface of the second sector portion 102, when the first sector portion 101 is reversed by 10°, the second sector portion 102 is also reversed by 10°. At this time, there is a 5° angle space between the second side surface of the first sector portion 101 and the second side surface of the second sector portion 102. Afterwards, the first sector portion 101 is driven forward by driving shaft 1, the second sector portion 102 continues to reverse under the action of inertia, as it is affected by factors such as frictional force and air resistance between the driving shaft 1 and the groove 4 during inertial rotation, resulting in a decrease in reverse speed. On the other hand, the first sector portion 101 does not experience a decrease in forward rotation speed under the drive of the driving shaft 1, therefore, the angle at which the second sector portion 102 reverses under inertial action is less than the angle at which the first sector portion 101 rotates forward, that is, the angle at which the second sector portion 102 reverses under inertial action is less than 2.5°, that is, a total angle at which the second sector portion 102 reverses is less than 2.5°.

It should be noted that when the radius of the groove 4 is greater than the radius of the driving shaft 1, under natural conditions, the inner wall of the groove 4 and the outer wall of the driving shaft 1 do not contact. However, during operation, due to back and forth rotation, the two may come into contact, resulting in frictional force, therefore even if there is no contact, under the influence of factors such as air resistance, the rod portion 3 will still lose energy during inertial motion, as a result, the rotation angle of rod portion 3 during inertial motion is less than the rotation angle of the driving shaft 1 during this process, ultimately achieving the goal of rotation range reduction.

In summary, the total angle of forward and reverse rotation of the first sector portion 101 is 20°, while the total angle of forward and reverse rotation of the second sector portion 102 is less than 20°. Therefore, the rotation angle of rod portion 3 is less than that of the driving shaft 1, thereby achieving the goal of reducing the rotation angle/range of rod portion 3.

### Second Embodiment

The difference between this embodiment and the first embodiment is that in the natural state, there is an angle of 2.5° between the first side surface of the first sector portion 101 and the first side surface of the second sector portion 102, and there is an angle of 2.5° between the second side surface of the first sector portion 101 and the second side surface of the second sector portion 102.

According to Example 1, it can be seen that while the first sector portion 102 rotates forward by 10°, the second sector portion 102 also rotates forward by 7.5°. At this time, there is a 5° angle space between the first side surface of the first sector portion 101 and the first side surface of the second sector portion 102. Afterwards, the first sector portion 102 reverses, and the second sector portion 102 rotates forward by less than 2.5° under inertia, that is, a total angle of the second sector portion 102 rotating forward is less than 10°.

At the same time as the first sector portion 102 is reversed by 10°, the second sector portion 102 is reversed by 7.5°. At this time, there is a 5° angle space between the second side surface of the first sector portion 101 and the second side surface of the second sector portion 102. Afterwards, the first sector portion 102 turns forward, and the second sector portion 102 reverses by less than 2.5° under inertial action, i.e., a total reverse rotation angle of the second sector portion 102 is less than 10°

In summary, the total angle of forward and reverse rotation of the first sector portion 101 is 20°, while the total angle of forward and reverse rotation of the second sector portion 102 is less than 20°. Therefore, the rotation angle of rod portion 3 is less than that of the driving shaft 1, thereby achieving the goal of reducing the rotation angle of rod portion 3.

Furthermore, the angle of the second sector portion 102 and the sum of the angles of the first sector portion 101 are 5-25 degrees less than 360 degrees, in order to prevent the decrease in rotation angle of the rod portion 3 compared to the driving shaft 1 from being too small or too large.

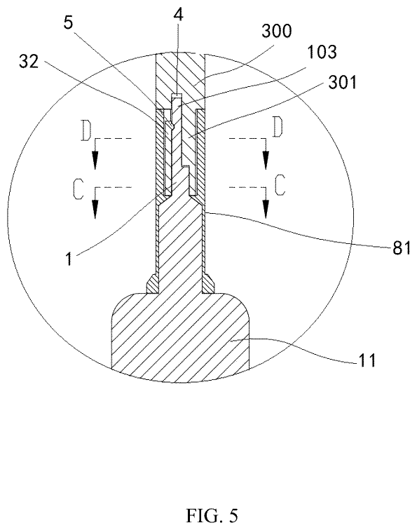

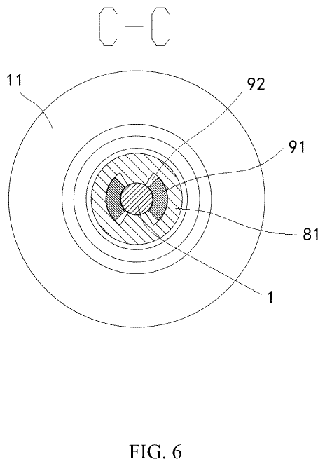

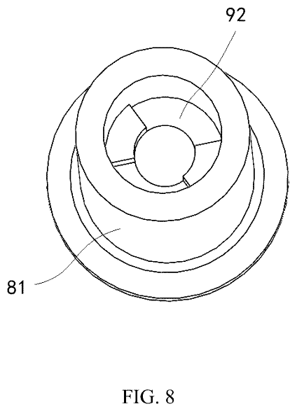

As can be seen from the above scheme, when the driving shaft 1 rotates, it will first rotate at a certain angle relative to the rod portion 3, and then drive the rod portion 3 to rotate. That is, there is a certain relative rotational space between the driving shaft 1 and the rod portion 3 in the circumferential direction. Therefore, when the driving shaft 1 rotates in a certain direction (such as forward) to a preset angle and stops rotating or reverses, the rod portion 3 may rotate at a certain angle due to inertia. To avoid this problem, referring to FIGS. 5-6, FIGS. 8-9. The electric toothbrush head of the present invention is also provided with a rotation limiting assembly 9, which includes a shell 81, a limiting protrusion 91 and a limiting groove 92. The lower part of the shell 81 is connected to a handle 11 of the electric toothbrush, and the limiting groove 92 is located in the shell 81 at an upper end thereof. The limiting protrusion 91 is set at the lower end of the rod portion 3. The rod portion 3 is inserted into the upper part of the shell 81 and connected to the driving shaft 1, the limiting protrusion 91 is received within the limiting groove 92, and the driving shaft 1 drives the rod portion 3 to rotate. After being driven by the driving shaft 1 to rotate a certain angle, the limiting protrusion 91 will come into contact with one end of the limiting groove 92. At this time, the limiting groove 92 will prevent the limiting protrusion 91 from continuing to rotate any excess angle due to inertia. That is, when the driving shaft 1 drives the rod portion 3 to rotate to a preset angle and stop rotating or reversing, the rod portion 3 drives the limiting protrusion 91 to precisely contact one end of the limiting groove 92, so that the rod portion 3 will also stop rotating and will not continue to rotate due to inertia, thereby ensuring the reduction effect.

Specifically, both the limiting protrusion 91 and the limiting groove 92 are in sector shape. An arc length of the limiting groove 92 is greater than that of the limiting protrusion 91. More specifically, the sector angle of the limiting groove 92 is greater than that of the limiting protrusion 91, and the angle difference between the two is equal to the designed rotation angle of the rod portion 3. In this embodiment, there are two limiting protrusions 91 and two limiting grooves 92. The two limiting protrusions 91 and the two limiting grooves 92 are arranged facing each other. During installation, the limiting protrusions 91 and the limiting grooves 92 are inserted into each other, so that the limiting protrusions 91 are restricted within the limiting grooves 92.

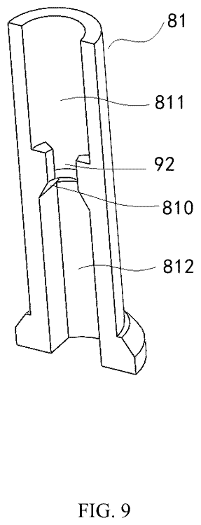

Furthermore, referring to FIG. 9, the shell 81 includes a top opening, a bottom opening, and a middle partition 810 with a channel. The internal space of the shell 81 is divided into an upper chamber 811 and a lower chamber 812 by the middle partition 810, and the channel connects the upper chamber 811 and the lower chamber 812. The limiting groove 92 is set in the upper chamber 811, and the rod portion 3 is inserted into the upper chamber 811 through the top opening of the shell 81. The driving shaft 1 is connected to the rod portion 3 through the bottom opening and the channel, and the lower chamber 812 is detachably sleeved on the brush handle 11 of the electric toothbrush.

When in use, first pass the driving shaft 1 of the electric toothbrush through the bottom opening and channel of the shell 81, so that the lower chamber 812 is sleeved onto the handle 11 of the electric toothbrush, and the shell 81 is connected to the brush handle 11 of the toothbrush. In this example, a protrusion 111 with a smaller size than the handle 11 is set at the connection between the handle 11 and the driving shaft 1 of the electric toothbrush, then, the lower chamber 812 of the shell 81 is fitted onto the protrusion 111, and the lower chamber 812 and protrusion 111 are connected with damping sliding. Then, insert the rod portion 3 into the upper chamber 811 from the top opening, so that the driving shaft 1 is inserted into the groove 4, and the first limiting portion 5 and the second limiting portion 6 are engaged to complete the connection of the rod portion 3 and the driving shaft 1. Due to the fact that the driving shaft 1 can rotate freely relative to the rod portion 3, in this embodiment, the second limiting portion 6 is an arc-shaped groove centered on the axis of the rod portion 3. Therefore, the first limiting portion 5 can be limited to move by the second limiting portion 6 in the axial direction, while there is a certain rotation range in the circumferential direction.

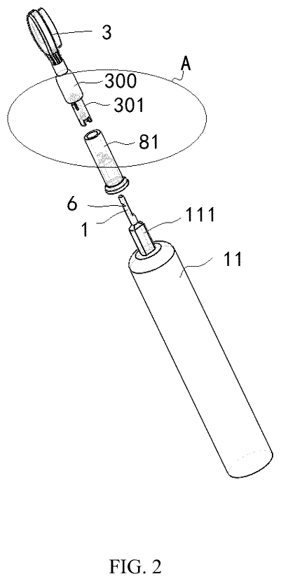

Due to the high-frequency movement of the rod portion 3 and the shell 81 driven by the driving shaft 1, the shell 81 may detach from the handle 11 under the influence of inertia. To solve the above problem, referring to FIG. 2, FIG. 3, and FIGS. 5, in this embodiment, the rod portion 3 is designed in two sections, which are defined as the rod upper section 300 and the rod lower section 301. The groove 4 and the protrusion 111 are set at the position of the rod upper section 300. The diameter of the rod upper section 300 is greater than that of the rod lower section 301, and a diameter of the rod upper section 300 is equal to an outer diameter of the shell 81. The rod upper section 300 and the rod lower section 301 directly form a limit plane 302, where the rod lower section 301 is inserted into the upper chamber 811 of the shell 81, and the limit plane 302 is in contact with the upper end of the shell 81, so that the shell 81 is axially clamped between the rod upper section 300 of the rod portion 3 and the handle 11, and the second limiting portion 6 set on the driving shaft 1 will restrict the axial movement of the first limiting portion 5 set inside the rod portion 3, so that the rod portion 3 cannot easily detach from the driving shaft 1 in the axial direction, indirectly limiting the shell 81 from detaching from the handle 11 of the electric toothbrush in the axial direction.

The embodiment of the present invention also discloses an electric toothbrush, as shown in FIGS. 1, 2 and 11. The electric toothbrush comprises a handle 11 and an electric toothbrush brush head as described above. The driving shaft 1 is provided on the handle 11, and the electric toothbrush brush head is connected to the driving shaft 1. In particular, the electric toothbrush brush head can be detachably connected to the driving shaft 1, such that the electric toothbrush brush head can be replaced.

It should be noted that the terms used here are only for describing specific embodiments, and are not intended to limit exemplary embodiments according to this application. As used here, unless otherwise explicitly stated in the context, the singular form is also intended to include the plural form. In addition, it should be understood that when the terms of including and/or including are used in this specification, they indicate the existence of features, steps, operations, devices, components, and/or their combinations.

In addition, it should be noted that the use of words such as first and second to define components is only for the purpose of distinguishing the corresponding components. Unless otherwise stated, the above words have no special meaning and cannot be understood as limiting the scope of protection of this application.

Although embodiments of the present invention have been shown and described, it can be understood by those skilled in the art that multiple variations, modifications, substitutions, and variations can be made to these embodiments without departing from the principles and spirit of the present invention. The scope of the present invention is limited by the accompanying claims and their equivalents.

What is claimed is:

1. An electric toothbrush brush head for connecting a driving shaft of an electric toothbrush, comprising:
a head portion with bristles;
a rod portion extending from the head portion; the rod portion comprising a groove for being detachably connected to the driving shaft, such that the driving shaft can be inserted into the groove and transmit a generated vibration to the rod portion; and
a rotation angle reducing assembly arranged between the rod portion and the driving shaft to allow a rotation angle of the rod portion less than that of the driving shaft.

2. The electric toothbrush brush head according to claim 1, wherein the driving shaft can rotate back and forth, and the rod portion and the driving shaft have relative rotational space, and the rotation angle reducing assembly comprises:
a first sector portion located at an end of the driving shaft; and
a second sector portion located within the groove, a radius of the groove is greater than that of the driving shaft, and a sum of the angles of the second sector portion and the first sector portion is less than 360°, such that there is a vacant angular space between the driving shaft and the side of the second sector, the driving shaft being idle for an angle before contacting a side surface of the second sector portion and driving the electric toothbrush head to rotate during each reciprocating rotation, and thus a rotation angle of the rod portion is less than that of the driving shaft.

3. The electric toothbrush brush head according to claim 2, further comprising a rotation limiting assembly, wherein the rotation limiting assembly is configured to limit an inertial rotation range of the rod portion.

4. The electric toothbrush brush head according to claim 3, wherein the rotation limiting assembly comprises a shell, a limiting groove and a limiting protrusion, a lower end of the shell is configured to be connected to a handle of the electric toothbrush, the limiting groove is located at the shell, the limiting protrusion is located on the rod portion, such that when the rod portion is inserted in the shell and connected to the driving shaft, the limiting protrusion is received in the limiting groove, during rotation, one end of the limiting protrusion can contact one end of the limiting groove after being driven by the driving shaft to rotate a certain angle, at this time, the limiting groove will prevent the limiting protrusion from continuing to rotate any excess angle due to inertia.

5. The electric toothbrush brush head according to claim 4, wherein the limiting protrusion and limiting groove are both in a sector shape, and an arc length of the limiting groove is greater than that of the limiting protrusion.

6. The electric toothbrush brush head according to claim 4, wherein the shell comprises a top opening, a bottom opening and a middle partition with a channel, an internal space of the shell is divided into an upper chamber and a lower chamber by the middle partition, and the channel connects the upper chamber and the lower chamber, the limiting groove is set in the upper chamber, and the rod portion is inserted into the upper chamber through the top opening of the shell, the driving shaft is connected to the rod portion through the bottom opening and the channel, and the lower chamber is detachably sleeved on the handle of the electric toothbrush.

7. The electric toothbrush brush head according to claim 1, wherein the head portion is detachably connected to the rod portion, the groove is provided with a first limiting portion, and the driving shaft is provided with a second limiting portion corresponding to the first limiting portion, the rod portion and the driving shaft are detachably connected through the fit of the first limiting portion and the second limiting portion.

8. The electric toothbrush brush head according to claim 7, an elastic portion is provided at a side wall of the groove, and the first limiting portion is set on a side of the elastic portion close to the driving shaft.

9. An electric toothbrush, comprising a handle and an electric toothbrush brush head according to claim 1, wherein the driving shaft being provided on the handle, and the electric toothbrush head is detachably connected to the driving shaft.
